(19) United States
(12) Patent Application Publication
(10) Pub. No.: US 2006/0116492 A1
(43) Pub. Date: Jun. 1, 2006

(54) Branched polymer

(75) Inventor: Ming Cheng, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/000,854

(22) Filed: Dec. 1, 2004

(51) Int. Cl. C08F 4/28

(52) U.S. Cl. 526/227; 526/348.7; 526/346; 526/319

(57) ABSTRACT

A copolymer comprises the reaction product of (a) at least one ethylenically-unsaturated monomer; (b) at least one N-substituted maleimide monomer; (c) at least one crosslinker comprising at least two ethylenically-unsaturated functional groups; (d) at least one free radical initiator; and (e) at least one chain transfer agent; wherein the reaction product is branched.

### FIELD

This invention relates to maleimide copolymers and to processes for their preparation.

### BACKGROUND

Highly branched macromolecules are known in polymer chemistry and are often prepared by step growth polymerization techniques. This mode of synthesis is multi-stage and complex. In general, it requires the use of protective group reactions and additional purifying operations after each stage, which makes synthesis not only time-consuming but also costly. Some highly branched end products (for example, dendrimers) are generally highly pure and also monodisperse (that is, all the macromolecules have the same molecular weight and, thus, there is no molecular weight distribution).

Hyperbranched polymers comprise another group of highly branched compounds, which, unlike the dendrimers, do exhibit a molecular weight distribution. Generally, hyperbranched polymers are obtained starting from ABₙ-type monomers in a one-stage reaction.

Branched polymers are used as additives in the preparation of polymeric materials, in order to obtain improvements in the physical and/or chemical properties of the polymeric material. Often, however, the branched additives lack certain desirable performance characteristics and/or are difficult to prepare.

### SUMMARY

Thus, we recognize that there is a need for branched, high performance polymers and for simple, cost-effective processes for their preparation. Such polymers will preferably exhibit a relatively high glass transition temperature (so as to facilitate their use in high temperature applications), a relatively low melt viscosity (to facilitate hot-melt processing), relatively good stability (chemical and/or thermal), and/or relatively good compatibility with commonly used polymeric materials.

The present invention provides such a polymer in the form of a copolymer comprising the reaction product of
(a) at least one ethylenically-unsaturated monomer;
(b) at least one N-substituted maleimide monomer;
(c) at least one crosslinker comprising at least two ethylenically-unsaturated functional groups;
(d) at least one free radical initiator; and
(e) at least one chain transfer agent;
   wherein the reaction product is branched. Preferably, the ethylenically-unsaturated monomer is a vinyl aromatic or vinyl ether monomer.

As used herein, the term “branched” means that the reaction product number average molecular weight (Mₙ) determined by multi-angle laser light scattering (MALLS) is at least double (preferably, at least triple; more preferably, at least ten times) the reaction product number average molecular weight (Mₙ) determined by gel permeation chromatography (GPC). This reflects the size exclusion basis for GPC molecular weight determinations, in which, for a given molecular weight, a higher degree of branching appears to indicate a lower molecular weight.

It has been discovered that branched maleimide copolymers can be relatively easily prepared using free radical polymerization techniques. The branched copolymers exhibit good stability characteristics (relative to, for example, branched polyesters and branched polyolefins) and relatively high glass transition temperatures. Thus, the copolymers are well-suited for use in high temperature applications (for example, aerospace and electronic applications). In addition, the copolymers exhibit good compatibility with commonly used polymeric resins (for example, epoxy resins) and can be added in amounts sufficient to impart significant toughness, while maintaining a viscosity that is low enough to allow hot-melt processing.

Thus, at least some embodiments of the branched copolymer of the invention meet the above-stated need in the art for high performance, branched polymers. When used as polymeric additives, the copolymers facilitate solvent-free processing, which can eliminate the need for resource-consuming solvent removal steps.

In another aspect, this invention also provides a process for preparing the branched copolymer of the invention, which comprises

(a) providing a mixture of
(1) at least one ethylenically-unsaturated monomer,
(2) at least one N-substituted maleimide monomer,
(3) at least one crosslinker comprising at least two ethylenically-unsaturated functional groups,
(4) at least one free radical initiator, and
(5) at least one chain transfer agent; and

(b) allowing the mixture to react to form a reaction product; wherein the amount of the crosslinker is sufficiently high that the reaction product is branched.

### DETAILED DESCRIPTION

Ethylenically-Unsaturated Monomer

Suitable monomers for use in preparing the branched copolymer include those that are ethylenically-unsaturated. Such monomers include substituted and unsubstituted olefins such as, for example, vinyl aromatics, vinyl ethers, vinyl esters, acryloyl- and methacryloyl-functional monomers, isobutene, and the like, and mixtures thereof. Preferred monomers include vinyl aromatics, vinyl ethers, and mixtures thereof.

A class of useful ethylenically-unsaturated monomers includes those represented by the following general Formula I: 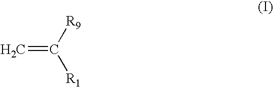
wherein: 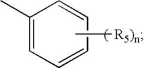
R₁ is
   —OR₆;
   —C(O)OR₇;
   —OC(O)R₈;
   ≡C—N; or
   —CH₃;
—R₉ is —H or —CH₃;
—R₅ is a halogen, —OH, —OR₁₀, or —C(O)OH;
—R₆, —R₇, —R₈, and —R₁₀ are monovalent aromatic groups, monovalent alicyclic groups, or monovalent C₁ to C₁₈ aliphatic groups; and
n is an integer of 0 to 5.
   Preferably, —R₁ is 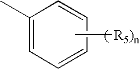
   or —OR₆; and —R₉ is —H.

Representative examples of suitable monomers include cyclohexyl vinyl ether, methyl vinyl ether, ethyl vinyl ether, isopropyl vinyl ether, n-butyl vinyl ether, isobutyl vinyl ether, hexadecyl vinyl ether, n-octadecyl vinyl ether, methyl acrylate, ethyl acrylate, n-butyl acrylate, isobutyl acrylate, t-butyl acrylate, ethyl methacrylate, butyl methacrylate, ethyltriglycol methacrylate, isobornyl acrylate, 2-((((butylamino)carbonyl)oxy)ethyl acrylate, acetoacetoxyethyl methacrylate, acetoacetoxyethyl acrylate, acetoacetoxypropyl acrylate, acetoacetoxybutyl acrylate, 2-methyl-2-(3-oxo-butyrylamino)-propyl methacrylate, 2-ethylhexyl acrylate, decyl acrylate, lauryl acrylate, stearyl acrylate, 2-hydroxyethyl acrylate, 2-hydroxypropyl acrylate, 2-hydroxyethyl methacrylate, 2-hydroxypropyl methacrylate, β-ethoxyethyl acrylate, 2-cyanoethyl acrylate, cyclohexyl acrylate, diethyl aminoethyl acrylate, hexyl methacrylate, decyl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, N-vinyl pyrrolidone, polycaprolactam acrylate, acryloyloxyethyl phthalate, acryloyloxy succinate, 2-ethylhexyl carbitol acrylate, ω-carboxy-polycaprolactam monoacrylate, phthalic acid monohydroxyethyl acrylate, vinyl acetate, vinyl trifluoroacetate, vinyl 2-ethylhexanoate, vinyl stearate, vinyl propionate, vinyl n-decanoate, vinyl benzoate, vinyl laurate, vinyl pivalate, vinyl behenate, styrene, 2,3,4,5,6-pentafluorostyrene, 2-chlorostyrene, 2-bromostyrene, 4-vinylbenzoic acid, 9-vinylanthracene, 2-vinylnaphthalene, 2,4,6-trimethylstyrene, 4-methoxystyrene, 4-vinylbiphenyl, vinyl toluenes, acrylonitrile, glycidyl methacrylate, n-methylol acrylamide-butyl ether, n-methylol acrylamide, acrylamide, dicyclopentenyloxyethyl acrylate, dicyclopentenyl acrylate, dicyclopentenyloxyethyl acrylate, acrylic acid, methacrylic acid, isobutene, and the like, and mixtures thereof.

Preferred monomers include cyclohexyl vinyl ether, methyl vinyl ether, ethyl vinyl ether, isopropyl vinyl ether, n-butyl vinyl ether, isobutyl vinyl ether, hexadecyl vinyl ether, n-octadecyl vinyl ether, styrene, 2,3,4,5,6-pentafluorostyrene, 2-chlorostyrene, 2-bromostyrene, 4-vinylbenzoic acid, 9-vinylanthracene, 2-vinylnaphthalene, 2,4,6-trimethylstyrene, 4-methoxystyrene, 4-vinylbiphenyl, 3-vinyl toluene, 4-vinyl toluene, and the like, and mixtures thereof. More preferred monomers include styrene, 3-vinyl toluene, 4-vinyl toluene, cyclohexyl vinyl ether, and the like, and mixtures thereof, with styrene, cyclohexyl vinyl ether, and the like, and mixtures thereof being most preferred.

N-Substituted Maleimide Monomer

Maleimide monomers suitable for use in preparing the branched copolymer include those that comprise a substituted or unsubstituted, nitrogen-bonded aryl group (preferably, C₆-C₁₄ aryl), cycloalkyl group (preferably, C₄-C₁₂ cycloalkyl), alkyl group (preferably, C₁-C₁₈ alkyl), or the like, or combinations thereof (preferably, an aryl or cycloalkyl group). Representative examples of useful maleimide monomers include N-phenylmaleimide, N-tolylmaleimide, N-cyclohexylmaleimide, N-methylmaleimide, N-ethylmaleimide, N-isopropylmaleimide, N-propylmaleimide, N-butylmaleimide, N-cyclopentylmaleimide, N-cyclobutylmaleimide, N-cycloheptylmaleimide, and the like, and mixtures thereof.

Preferred maleimide monomers include N-phenylmaleimide, N-cyclohexylmaleimide, N-methylmaleimide, and the like, and mixtures thereof.

Multifunctional Crosslinker

Compounds useful as crosslinkers in preparing the branched copolymer include those that comprise at least two ethylenically-unsaturated functional groups. Such compounds include multifunctional ethylenically unsaturated monomer(s) (compounds possessing at least two polymerizable double bonds in one molecule), for example, divinyl aromatics, divinyl ethers, multifunctional maleimides, multifunctional acrylates and methacrylates, and the like, and mixtures thereof. Preferred are divinyl aromatics, divinyl ethers, multifunctional maleimides, and the like, and mixtures thereof.

Representative examples of such multifunctional crosslinkers include divinylbenzene, 1,4-cyclohexanedimethanol divinyl ether, 1,1′-(methylenedi-4,1-phenylene)bismaleimide, ethylene glycol diacrylate; 1,2-propylene glycol diacrylate; 1,3-butylene glycol diacrylate; 1,6-hexanediol diacrylate; neopentylglycol diacrylate; trimethylolpropane triacrylate; polyoxyalkylene glycol diacrylates such as dipropylene glycol diacrylate, triethylene glycol diacrylates, tetraethylene glycol diacrylates, polyethylene glycol diacrylate; ethylene glycol dimethacrylate; 1,2-propylene glycol dimethacrylate; 1,3-butylene glycol dimethacrylate; 1,6-hexanediol dimethacrylate; neopentylglycol dimethacrylate; Bisphenol A dimethacrylate; diurethane dimethacrylate; trimethylolpropane trimethacrylate; polyoxyalkylene glycol dimethacrylates such as dipropylene glycol dimethacrylate, triethylene glycol dimethacrylates, tetraethylene glycol dimethacrylates, polyethylene glycol dimethacrylate; N,N-methylenebismethacrylamide; diallyl phthalate; triallyl cyanurate; triallyl isocyanurate; allyl acrylate; allyl methacrylate; diallyl fumarate; diallyl isophthalate; diallyl tetrabromophthalate; pentaerythritol tetraacrylate; di-trimethylpropane tetraacrylate; dipentaerythritol pentaacrylate; and the like; and mixtures thereof.

Preferred crosslinkers include divinylbenzene, 1,4-cyclohexanedimethanol divinyl ether, 1,1′-(methylenedi-4,1-phenylene)bismaleimide, and the like, and mixtures thereof.

Initiators

Initiators that are useful in preparing the branched copolymers are free radical initiators, which include those described in Chapters 20 & 21 of Macromolecules, Vol. 2, 2nd Ed., H. G. Elias, Plenum Press, New York (1984). Useful thermal initiators include, but are not limited to, the following: (1) azo compounds such as, for example, 2,2′-azo-bis(isobutyronitrile), dimethyl 2,2′-azo-bis(isobutyrate), azo-bis(diphenyl methane), and 4,4′-azo-bis(4-cyanopentanoic acid); (2) peroxides such as, for example, hydrogen peroxide, benzoyl peroxide, cumyl peroxide, tert-butyl peroxide, cyclohexanone peroxide, glutaric acid peroxide, lauroyl peroxide, and methyl ethyl ketone peroxide; (3) hydroperoxides such as, for example, tert-butyl hydroperoxide and cumene hydroperoxide; (4) peracids such as, for example, peracetic acid, perbenzoic acid, potassium persulfate, and ammonium persulfate; (5) peresters such as, for example, diisopropyl percarbonate; (6) thermal redox initiators; and the like; and mixtures thereof.

Useful photochemical initiators include but are not limited to benzoin ethers such as, for example, diethoxyacetophenone; oximino-ketones; acylphosphine oxides; diaryl ketones such as, for example, benzophenone and 2-isopropyl thioxanthone; benzil and quinone derivatives; 3-ketocoumarins such as, for example, those described by S. P. Pappas, J. Rad. Cur., 7, 6 (1987), and photochemical redox initiators. Thermal initiators are generally preferred, with azo compounds and peroxides (even more preferably, azo compounds; most preferably, 2,2′-azo-bis(isobutyronitrile)) being more preferred.

Chain Transfer Agents

Branched copolymer molecular weight can be controlled through the use of chain transfer agents, including, for example, mercaptans, disulfides, carbon tetrabromide, carbon tetrachloride, and the like, and mixtures thereof. Useful chain transfer agents also include cobalt chelates (such as, for example, those described in U.S. Pat. No. 4,680,352 (Janowicz et al.) and U.S. Pat. No. 4,694,054 (Janowicz), the descriptions of which are incorporated herein by reference) and oligomeric chain transfer agents (such as, for example, those described in U.S. Pat. No. 5,362,826 (Berge et al.), U.S. Pat. No. 5,773,534 (Antonelli et al.), and U.S. Pat. No. 6,635,690 (Heilmann et al.), the descriptions of which are incorporated herein by reference).

Preparation of Branched Copolymer

Methods for preparing the branched copolymers of the invention include, for example, emulsion polymerization, suspension polymerization, and solution polymerization. These methods use free radical initiators (optionally, along with initiation accelerators) that, through various techniques, can be decomposed to form free radicals. Once in radical form, the initiators can react with the above-described monomers to thereby start the polymerization process.

Free radical initiators can be decomposed via homolytic bond cleavage by using heat energy (thermolysis), light energy (photolysis), or appropriate catalysts. Light energy can be supplied by means of visible or ultraviolet sources, including low intensity fluorescent black light lamps, medium pressure mercury arc lamps, and germicidal mercury lamps.

Catalyst-induced homolytic decomposition of the initiator typically involves an electron transfer mechanism resulting in a reduction-oxidation (redox) reaction. (This method of initiation is described, for example, by Elias in Macromolecules, supra). Initiators such as persulfates, peroxides, and hydroperoxides are generally more susceptible to this type of decomposition. Useful catalysts include, for example, amines, metal ions used in combination with peroxide or hydroperoxide initiators, and bisulfite or mercapto-based compounds used in combination with persulfate initiators.

Preferred methods of initiation comprise thermolysis or catalysis. More preferred is thermolysis, which has an additional advantage in that it provides ease of control of reaction rate and exotherm.

Emulsion polymerization techniques can be used to prepare the copolymers, if desired. Such techniques involve dispersion of the monomers, crosslinker, initiator, and chain transfer agent in a continuous phase (typically water) with the aid of a surfactant and initiation of polymerization. Other components can be present including stabilizers (for example, copolymerizable surfactants) and catalysts. The product of this type of polymerization is typically a colloidal dispersion of polymer particles that is often referred to as “latex.”

The branched copolymers of the invention can also be made by suspension polymerization techniques. For example, colloidal silica in combination with a promoter (for example, an amphiphilic polymer) can be used as a stabilizer. Using such a process, surfactant-free copolymers can be obtained with a relatively narrow particle size distribution.

Bulk polymerization methods can also be used, but a preferred method for preparing the branched copolymers is by solution polymerization. In one illustrative solution polymerization method, the monomers, crosslinker, chain transfer agent, and one or more inert solvents can be charged into a reaction vessel. Suitable solvents include those that are capable of dissolving the monomers and/or the resulting copolymer. Preferably, the solvent is a polar organic solvent. After the monomers are charged, a free radical initiator (preferably, a thermal free radical initiator; more preferably, an azo or peroxide compound, for reasons of solubility and control of reaction rate) can be added. The vessel can be purged with nitrogen to create an inert atmosphere. The reaction can be allowed to proceed, preferably using elevated temperatures, to achieve a desired conversion of the monomers to copolymer.

Suitable solvents for solution polymerizations include but are not limited to esters (for example, ethyl acetate and butyl acetate); ketones (for example, methyl ethyl ketone and acetone); alcohols (for example, methanol and ethanol); aliphatic hydrocarbons (for example, hexane and heptane); aromatics (for example, toluene and chlorobenzene); alicyclics (for example, cyclohexane); ethers (for example, tetrahydrofuran and methyl tert-butyl ether); and the like; and mixtures thereof. The solvent, however, can be any substance that is liquid in a temperature range of, for example, about −10° C. to 120° C., that does not interfere with the energy source or catalyst used to dissociate the initiator to form free radicals, that is inert to the reactants and product, and that will not otherwise adversely affect the reaction. The amount of solvent, when used, can generally be about 30 to 80 percent by weight, based on the total weight of the reactants and solvent. Preferably, the amount of solvent ranges from about 40% to 65% by weight, based upon the total weight of the reactants and solvent, to yield fast reaction times.

If desired, copolymers prepared by solution polymerization can optionally be inverted to yield dispersions of small average particle size (typically less than about one micrometer). Inversion of copolymers can occur in aqueous carrier or aqueous solvent provided that the copolymers either contain ionic functionality or contain acidic or basic functionality that upon neutralization yields ionic functionality.

In carrying out the preparation process, essentially any order and manner of combination of the components can be utilized, but the use of stirring (for example, mechanical stirring or high shear mixing) is generally preferred. Preferably, the components are combined at a temperature that is sufficiently low to minimize initiation.

The relative amounts of the monomers, crosslinker, chain transfer agent, and initiator (collectively termed the “monomer composition”) can vary depending upon the desired properties of the product polymer. Generally, the monomer composition can comprise at least about 20 weight percent (preferably, at least about 30 weight percent; more preferably, at least about 40 weight percent) of one or more ethylenically-unsaturated monomers; at least about 40 weight percent (preferably, at least about 45 weight percent; more preferably, at least about 50 weight percent) of one or more N-substituted maleimide monomers; at least about 1 weight percent (preferably, at least about 2 weight percent; more preferably, at least about 3 weight percent) of one or more crosslinkers; at least about 1 weight percent (preferably, at least about 2 weight percent; more preferably, at least about 3 weight percent) of one or more free radical initiators; and at least about 1 weight percent (preferably, at least about 2 weight percent; more preferably, at least about 3 weight percent) of one or more chain transfer agents; based upon the total weight of the monomer composition.

Generally, the monomer composition can comprise up to about 50 weight percent (preferably, up to about 45 weight percent; more preferably, up to about 40 weight percent) of one or more ethylenically-unsaturated monomers; up to about 70 weight percent (preferably, up to about 60 weight percent; more preferably, up to about 50 weight percent) of one or more N-substituted maleimide monomers; up to about 15 weight percent (preferably, up to about 5 weight percent; more preferably, up to about 3 weight percent) of one or more crosslinkers; up to about 15 weight percent (preferably, up to about 10 weight percent; more preferably, up to about 3 weight percent) of one or more free radical initiators; and up to about 20 weight percent (preferably, up to about 10 weight percent; more preferably, up to about 3 weight percent) of one or more chain transfer agents; based upon the total weight of the monomer composition.

Thus, the monomer composition can comprise, for example, from about 20 to about 40 weight percent, from about 20 to about 45 weight percent, from about 20 to about 50 weight percent, from about 30 to about 40 weight percent, from about 30 to about 45 weight percent, from about 30 to about 50 weight percent, from about 40 to about 45 weight percent, or from about 40 to about 50 weight percent, ethylenically-unsaturated monomer (and ranges of amounts of the other four components that are similarly compiled from the above-listed lower and upper limits for these components).

Preferably, the amount of crosslinker is chosen to be sufficiently high (relative to the amounts of the monomers) to provide non-linear polymer and is counterbalanced by an amount of chain transfer agent that is empirically determined to be sufficient to prevent gellation. Preferably, the mole ratio of crosslinker to chain transfer agent is less than about 1.25.

The copolymer can be isolated, for example, by solvent evaporation or by precipitation (for example, by pouring the reaction mixture into a liquid in which the copolymer is substantially insoluble such as, for example, methanol or isopropanol) followed by filtration of the solid copolymer. Residual volatile components can be removed by application of heat or vacuum.

### EXAMPLES

Objects and advantages of this invention are further illustrated by the following examples, but the particular materials and amounts thereof recited in these examples, as well as other conditions and details, should not be construed to unduly limit this invention.

Unless otherwise noted, all chemicals, solvents, and reagents were or can be obtained from Aldrich Chemical Co., Milwaukee, Wis.

### GLOSSARY

As used herein,
“AIBN” refers to 2,2′-azo-bis(isobutyronitrile);
“DPI” refers to 4,5-diphenylimidazole;
“BISMALEIMIDE” refers to 1,1′-(methylenedi-4,1-phenylene)bismaleimide;
“EPON 828” refers to a Bisphenol A epoxy resin available from Resolution Performance Products, Houston, Tex.;
“RSL 1462” refers to an epichlorohydrin epoxy resin available from Resolution Performance Products, Houston, Tex.;
“IPDH” refers to isophthalic dihydrazide, available from TCI America, Portland, Oreg.; and
“LM-10” refers to fumed silica obtained from Nippon Chemical Co., Tokyo, Japan.
   Molecular Weight Determination

The number average and weight average molecular weights of each of the polymers of Examples 1-5 and Comparative Example 1 were measured using both gel permeation chromatography (GPC) and multi-angle laser light scattering (MALLS).

Molecular weight measurements by GPC were made by eluting a tetrahydrofuran solution of each polymer sample through GPC columns with tetrahydrofuran at a flow rate of 1 mL per minute using a Model 1515 isocratic high performance liquid chromatography pump (available from Waters Corp., Milford, Mass.) and a Model 2410 refractive index detector (available from Waters Corp., Milford, Mass.). The GPC columns and detector were calibrated by using monodisperse polystyrene standards.

Molecular weight measurements by MALLS were made by eluting a 1 mL tetrahydrofuran solution of each polymer sample through mixed bed and 500 Angstrom high performance liquid chromatography (HPLC) columns (available from Jordi FLP, Bellingham, Mass.) using a Model 2695 Alliance injector and pump system (available from Waters Corp., Milford, Mass.) and a Model DAWN EOS light scattering detector, available from Wyatt Technology Corp., Santa Barbara, Calif.

The molecular weight and glass transition temperature data for each of the polymers of Examples 1-5 and Comparative Example 1 are given in Table 1. In Table 1, “Mₙ” refers to the number average molecular weight, “M_{w}” refers to the weight average molecular weight, “PDI” refers to the polydispersity index, which is the ratio of the weight average molecular weight to the number average molecular weight, and “T_{g}” refers to the glass transition temperature of the polymer. In Table 1, “n/a” means that the data was not obtained.

Glass Transition Temperature Determination

Glass transition temperature measurements were made using a Model Q1000 differential scanning calorimeter (available from TA Instruments, New Castle, Del.) with all polymer samples sealed in crimped aluminum pans. The rate of heating of the samples was 10° C. per minute.

Complex Viscosity Determination

Dynamic mechanical analysis (DMA) was carried out using a Dynamic Mechanical Analyzer RDAII obtained from Rheometric Scientific, Inc., Piscataway, N.J., on samples that had been pressed into sheets each having a thickness of approximately 1 millimeter and then cut into circles each having a diameter of approximately 1 inch.

### Example 1

Preparation of a Branched Polymer of Styrene, Divinylbenzene, and N-Phenylmaleimide

A mixture of styrene (9.0 g), divinylbenzene (1.41 g), N-phenylmaleimide (18.71 g), 1-octadecanethiol (6.19 g), AIBN (3.55 g), and methyl ethyl ketone (220 g), having a molar ratio of divinylbenzene to 1-octadecanethiol of 0.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (600 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Example 2

Preparation of a Branched Polymer of Styrene, Divinylbenzene, and N-Phenylmaleimide

A mixture of styrene (8.0 g), divinylbenzene (1.25 g), N-phenylmaleimide (16.60 g), 1-octadecanethiol (2.8 g), AIBN (1.58 g), and methyl ethyl ketone (172 g), having a molar ratio of divinylbenzene to 1-octadecanethiol of 1 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (600 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Example 3

Preparation of a Branched Polymer of Styrene, Divinylbenzene, N-Phenylmaleimide, and Glycidyl Methacrylate

A mixture of styrene (8.0 g), divinylbenzene (1.43 g), N-phenylmaleimide (19.0 g), glycidyl methacrylate (1.56 g), 1-octadecanethiol (6.29 g), AIBN (3.6 g), and methyl ethyl ketone (226 g), having a molar ratio of divinylbenzene to 1-octadecanethiol of 0.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (600 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Example 4

Preparation of a Polymer of Cyclohexyl Vinyl Ether, 1,4-Cyclohexanedimethanol Divinyl Ether, and N-Cyclohexylmaleimide

A mixture of cyclohexyl vinyl ether (1.00 g), 1,4-cyclohexanedimethanol divinyl ether (0.19 g), N-cyclohexylmaleimide (1.78 g), 1-octadecanethiol (0.57 g), AIBN (0.33 g), and methyl ethyl ketone (21.9 g), having a molar ratio of 1,4-cyclohexanedimethanol divinyl ether to 1-octadecanethiol of 0.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (60 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Example 5

Preparation of a Polymer of Styrene, Bismaleimide, and N-Phenylmaleimide

A mixture of styrene (1.05 g), bismaleimide (0.36 g), N-phenylmaleimide (1.40 g), 1-octadecanethiol (0.58 g), AIBN (0.33 g), and methyl ethyl ketone (21 g), having a molar ratio of bismaleimide to 1-octadecanethiol of 0.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (60 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Comparative Example 1

Preparation of a Linear Polymer of Styrene and N-Phenylmaleimide

A mixture of styrene (11.25 g), N-phenylmaleimide (18.71 g), 1-octadecanethiol (6.19 g), AIBN (3.55 g), and methyl ethyl ketone (220 g) was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture was poured into methanol (600 mL) in a beaker. The resultant precipitate was vacuum filtered using a fritted glass funnel. The filtered solid product was washed with methanol and was then dried in a vacuum oven at room temperature and approximately 1 mm Hg to afford the dry product. The polymer molecular weight and T_{g} data are given in Table 1.

### Comparative Example 2

Preparation of a Polymer of Styrene, Divinylbenzene, and N-Phenylmaleimide

A mixture of styrene (10.00 g), divinylbenzene (1.56 g), N-phenylmaleimide (20.78 g), 1-octadecanethiol (1.38 g), AIBN (0.79 g), and methyl ethyl ketone (196 g), having a molar ratio of divinylbenzene to 1-octadecanethiol of 2.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture formed a gel.

### Comparative Example 3

Preparation of a Polymer of Styrene, Divinylbenzene, and N-Phenylmaleimide

A mixture of styrene (0.80 g), divinylbenzene (0.06 g), N-phenylmaleimide (1.48 g), 1-octadecanethiol (0.10 g), AIBN (0.06 g), and methyl ethyl ketone (14.10 g), having a molar ratio of divinylbenzene to 1-octadecanethiol of 1.25 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture formed a gel.

### Comparative Example 4

Preparation of a Polymer of Styrene, Divinylbenzene, N-Phenylmaleimide, and Glycidyl Methacrylate

A mixture of styrene (8.60 g), divinylbenzene (1.54 g), N-phenylmaleimide (20.43 g), glycidyl methacrylate (1.68 g), 1-octadecanethiol (1.35 g), AIBN (0.77 g), and methyl ethyl ketone (195 g), having a molar ratio of divinylbenzene to 1-octadecanethiol of 2.5 to 1, was stirred in a round bottom flask at room temperature. Nitrogen gas was bubbled through the stirring mixture for 15 minutes. The mixture was then stirred and heated to 64° C. under a nitrogen atmosphere for 10 hours, after which time it was allowed to cool to room temperature. The mixture formed a gel.

TABLE 1
Molecular Weight and Glass Transition Temperature (T_{g}) Data

| | GPC Molecular Weight | | | MALLS Molecular Weight | | | Tg |
|---|---|---|---|---|---|---|---|
| Polymer | Mₙ | M_{w} | PDI | Mₙ | M_{w} | PDI | (° C.) |
| Compara- | 16,300 | 57,400 | 3.53 | 22,800 | 42,400 | 1.86 | 210 |
| tive 1 | | | | | | | |
| Example 1 | 8,110 | 21,100 | 2.60 | 26,800 | 82,000 | 3.06 | 194 |
| Example 2 | 12,500 | 89,200 | 7.15 | 250,000 | 1,170,000 | 4.66 | 193 |
| Example 3 | 6,110 | 19,900 | 3.26 | 506,000 | 1,070,000 | 2.12 | 199 |
| Example 4 | 2,400 | 3,110 | 1.30 | n/a | n/a | n/a | 190 |
| Example 5 | 7,060 | 76,400 | 10.8 | 464,000 | 1,900,000 | 4.09 | 212 |

Blend Number 1
Preparation of an Epoxy Blend

A mixture of 20 weight percent of the product of Example 1 and 80 weight percent of RSL 1462 was prepared by heating and stirring the combined materials at 150° C. for 30 minutes. The mixture (7.03 g; 29 parts by weight), IPDH (1.47 g; 6 parts by weight), and LM-10 (15.77 g; 65 parts by weight) were then mixed at 85° C. using a Model DAC-100 mixer (available from Dantco Mixers Corporation, Paterson, N.J.). DMA measurements were carried out as described above. The DMA data are shown in Table 2.

TABLE 2
DMA Data for Blend Number 1

| Temperature | Complex Viscosity |
|---|---|
| (° C.) | (Pa · s) |
| 25.4 | 24,300 |
| 50.6 | 2,730 |
| 75.5 | 275 |
| 101.2 | 10.3 |

Comparative Blend Number 1
Preparation of an Epoxy Blend

A mixture of 20 weight percent of the product of Comparative Example 1 and 80 weight percent of RSL 1462 was prepared by heating and stirring the combined materials at 150° C. for 30 minutes. The mixture (5.13 g; 29 parts by weight), IPDH (1.07 g; 6 parts by weight), and LM-10 (11.51 g; 65 parts by weight) were then mixed at 85° C. using a Model DAC-100 mixer (available from Dantco Mixers Corporation, Paterson, N.J.). DMA measurements were carried out as described above. The DMA data are shown in Table 3.

TABLE 3
DMA Data for Comparative Blend Number 1

| Temperature | Complex Viscosity |
|---|---|
| (° C.) | (Pa · s) |
| 25.9 | 4,210,000 |
| 49.8 | 1,440,000 |
| 75.6 | 346,000 |
| 101.4 | 55,700 |

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A copolymer comprising the reaction product of
(a) at least one ethylenically-unsaturated monomer;
(b) at least one N-substituted maleimide monomer;
(c) at least one crosslinker comprising at least two ethylenically-unsaturated functional groups;
(d) at least one free radical initiator; and
(e) at least one chain transfer agent;
wherein said reaction product is branched.

2. The copolymer of claim 1, wherein said ethylenically-unsaturated monomer is selected from the group consisting of vinyl aromatics, vinyl ethers, vinyl esters, acryloyl- and methacryloyl-functional monomers, isobutene, and mixtures thereof.

3. The copolymer of claim 2, wherein said ethylenically-unsaturated monomer is selected from the group consisting of vinyl aromatics, vinyl ethers, and mixtures thereof.

4. The copolymer of claim 1, wherein said ethylenically-unsaturated monomer is selected from those represented by the following general Formula I: 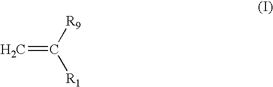
wherein: 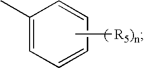
—R₁ is
—OR₆;
—C(O)OR₇;
—OC(O)R₈;
—C—N; or
—CH₃;
—R₉ is —H or —CH₃;
—R₅ is a halogen, —OH, —OR₁₀, or —C(O)OH;
—R₆, —R₇, —R₈, and —R₁₀ are monovalent aromatic groups, monovalent alicyclic groups, or monovalent C₁ to C₁₈ aliphatic groups; and
n is an integer of 0 to 5.

5. The copolymer of claim 4, wherein said —R₁ is 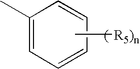
and said —R₉ is —H.

6. The copolymer of claim 4, wherein said —R₁ is —OR₆ and said —R₉ is —H.

7. The copolymer of claim 1, wherein said ethylenically-unsaturated monomer is selected from the group consisting of cyclohexyl vinyl ether, methyl vinyl ether, ethyl vinyl ether, isopropyl vinyl ether, n-butyl vinyl ether, isobutyl vinyl ether, hexadecyl vinyl ether, n-octadecyl vinyl ether, styrene, 2,3,4,5,6-pentafluorostyrene, 2-chlorostyrene, 2-bromostyrene, 4-vinylbenzoic acid, 9-vinylanthracene, 2-vinylnaphthalene, 2,4,6-trimethylstyrene, 4-methoxystyrene, 4-vinylbiphenyl, 3-vinyl toluene, 4-vinyl toluene, and mixtures thereof.

8. The copolymer of claim 7, wherein said ethylenically-unsaturated monomer is selected from the group consisting of styrene, 3-vinyl toluene, 4-vinyl toluene, cyclohexyl vinyl ether, and mixtures thereof.

9. The copolymer of claim 1, wherein said N-substituted maleimide monomer comprises a substituted or unsubstituted, nitrogen-bonded moiety that is selected from the group consisting of aryl groups, cycloalkyl groups, alkyl groups, and combinations thereof.

10. The copolymer of claim 9, wherein said moiety is selected from the group consisting of C₆-C₁₄ aryl, C₄-C₁₂ cycloalkyl, C₁-C₁₈ alkyl, and combinations thereof.

11. The copolymer of claim 9, wherein said moiety is aryl or cycloalkyl.

12. The copolymer of claim 9, wherein said N-substituted maleimide monomer is selected from the group consisting of N-phenylmaleimide, N-tolylmaleimide, N-cyclohexylmaleimide, N-methylmaleimide, N-ethylmaleimide, N-isopropylmaleimide, N-propylmaleimide, N-butylmaleimide, N-cyclopentylmaleimide, N-cyclobutylmaleimide, N-cycloheptylmaleimide, and mixtures thereof.

13. The copolymer of claim 1, wherein said crosslinker is selected from the group consisting of divinyl aromatics, divinyl ethers, multifunctional maleimides, multifunctional acrylates and methacrylates, and mixtures thereof.

14. The copolymer of claim 1, wherein said crosslinker is selected from the group consisting of divinylbenzene, 1,4-cyclohexanedimethanol divinyl ether, 1,1′-(methylenedi-4,1-phenylene)bismaleimide, and mixtures thereof.

15. The copolymer of claim 1, wherein said free radical initiator is selected from the group consisting of azo compounds, peroxides, hydroperoxides, peracids, peresters, thermal redox initiators, and mixtures thereof.

16. The copolymer of claim 1, wherein said chain transfer agent is selected from the group consisting of mercaptans, disulfides, carbon tetrabromide, carbon tetrachloride, cobalt chelates, oligomeric chain transfer agents, and mixtures thereof.

17. The copolymer of claim 1, wherein the number average molecular weight (Mₙ) of said reaction product determined by multi-angle laser light scattering (MALLS) is at least triple the number average molecular weight (Mₙ) of said reaction product determined by gel permeation chromatography (GPC).

18. The copolymer of claim 1, wherein the number average molecular weight (Mₙ) of said reaction product determined by multi-angle laser light scattering (MALLS) is at least ten times the number average molecular weight (Mₙ) of said reaction product determined by gel permeation chromatography (GPC).

19. The copolymer of claim 1, wherein said reaction product comprises from about 20 weight percent to about 50 weight percent of said ethylenically-unsaturated monomer and from about 40 weight percent to about 70 weight percent of said N-substituted maleimide monomer.

20. A copolymer comprising the reaction product of
(a) at least one ethylenically-unsaturated monomer selected from the group consisting of styrene, cyclohexyl vinyl ether, and mixtures thereof;
(b) at least one N-substituted maleimide monomer selected from the group consisting of N-phenylmaleimide, N-cyclohexylmaleimide, N-methylmaleimide, and mixtures thereof;
(c) at least one crosslinker selected from the group consisting of divinyl aromatics, divinyl ethers, multifunctional maleimides, and mixtures thereof;
(d) at least one free radical initiator; and
(e) at least one chain transfer agent;
wherein said reaction product is branched.

21. A process comprising
(a) providing a mixture of
(1) at least one ethylenically-unsaturated monomer,
(2) at least one N-substituted maleimide monomer,
(3) at least one crosslinker comprising at least two ethylenically-unsaturated functional groups,
(4) at least one free radical initiator, and
(5) at least one chain transfer agent; and
(b) allowing said mixture to react to form a reaction product;
wherein the amount of said crosslinker is sufficiently high that said reaction product is branched.

22. The process of claim 21, wherein the amount of said crosslinker is at least about one percent by weight, based upon the total weight of said mixture.

23. A copolymer prepared by the process of claim 21.
